(19) United States
(12) Patent Application Publication
(10) Pub. No.: US 2024/0119347 A1
(43) Pub. Date: Apr. 11, 2024

(54) TRAINING A BIDIRECTIONAL ENCODER REPRESENTATIONS FROM TRANSFORMERS (BERT) MODEL TO GENERATE A SOFTWARE REPRESENTATION FROM AN INTERMEDIATE REPRESENTATION OF A SOFTWARE PACKAGE

(71) Applicant: International Business Machines Corporation, Armonk, NY (US)

(72) Inventors: Soyeon Park, Gyeongsangbuk-Do (KR); Dhilung Kirat, Hartsdale, NY (US); Sanjeev Das, White Plains, NY (US); Douglas Lee Schales, Ardsley, NY (US); Taesung Lee, Ridgefield, CT (US); Jiyong Jang, Chappaqua, NY (US)

(21) Appl. No.: 17/962,330

(22) Filed: Oct. 7, 2022

(51) Int. Cl. G06N 20/00; G06K 9/62

(52) U.S. Cl. CPC G06N 20/00; G06K 9/6215

(57) ABSTRACT

A computer-implemented method according to one embodiment includes training a bidirectional encoder representations from transformers (BERT) model to generate a software representation. An intermediate representation (IR) of a software package is input to the trained BERT model, and a software representation corresponding to the software package is received as output from the trained BERT model. A computer program product according to another embodiment includes a computer readable storage medium having program instructions embodied therewith. The program instructions are readable and/or executable by a computer to cause the computer to perform the foregoing method. A system according to another embodiment includes a processor, and logic integrated with the processor, executable by the processor, or integrated with and executable by the processor. The logic is configured to perform the foregoing method.

### BACKGROUND

The present invention relates to software representations, and more specifically, this invention relates to training a bidirectional encoder representations from transformers (BERT) model to use an intermediate representation (IR) input to output a software representation in the form of embedding, e.g., feature vectors, tensors, etc.

An IR is a data structure or code used internally by a compiler and/or virtual machine to represent source code. A relatively useful IR is typically accurate in that it is capable of representing the source code without losing information, yet independent of any particular source or target language. An IR may take one of several forms, e.g., such as an in-memory data structure.

Obtaining an accurate software representation is useful in many security applications, e.g., such as one-day vulnerability detection, malware detection, function signature inference, etc. As LLVM IR is more independent of a programming language, architecture, and platform than binary and source code is, in some cases, IR may be a relatively most effective layer to represent software.

### SUMMARY

A computer-implemented method according to one embodiment includes training a bidirectional encoder representations from transformers (BERT) model to generate a software representation. An intermediate representation (IR) of a software package is input to the trained BERT model, and a software representation corresponding to the software package is received as output from the trained BERT model.

A computer program product according to another embodiment includes a computer readable storage medium having program instructions embodied therewith. The program instructions are readable and/or executable by a computer to cause the computer to perform the foregoing method.

A system according to another embodiment includes a processor, and logic integrated with the processor, executable by the processor, or integrated with and executable by the processor. The logic is configured to perform the foregoing method.

Other aspects and embodiments of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one embodiment of the present invention.

FIG. 2A is a flowchart of a method, in accordance with one embodiment of the present invention.

FIG. 2B includes sub-operations of an operation of FIG. 2A, in accordance with one embodiment of the present invention.

FIG. 2C includes sub-operations of an operation of FIG. 2A, in accordance with one embodiment of the present invention.

FIG. 2D includes sub-operations of an operation of FIG. 2A, in accordance with one embodiment of the present invention.

FIG. 3 is a representational architecture, in accordance with one embodiment of the present invention.

FIG. 4A is a representation of sample IRs, in accordance with one embodiment of the present invention.

FIG. 4B is a representation of the sample IRs of FIG. 4A, in accordance with one embodiment of the present invention.

FIG. 5 is a representation, in accordance with one embodiment of the present invention.

FIG. 6 is a representation of a progression of splitting symbolic identifiers, in accordance with one embodiment of the present invention.

FIG. 7 is a representation, in accordance with one embodiment of the present invention.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred embodiments of systems, methods and computer program products for training a bidirectional encoder representations from transformers (BERT) model to use an intermediate representation (IR) input to output a software representation in the form of embedding, e.g., feature vectors, tensors, etc.

In one general embodiment, a computer-implemented method includes training a bidirectional encoder representations from transformers (BERT) model to generate a software representation. An intermediate representation (IR) of a software package is input to the trained BERT model, and a software representation corresponding to the software package is received as output from the trained BERT model.

In another general embodiment, a computer program product includes a computer readable storage medium having program instructions embodied therewith. The program instructions are readable and/or executable by a computer to cause the computer to perform the foregoing method.

In another general embodiment, a system includes a processor, and logic integrated with the processor, executable by the processor, or integrated with and executable by the processor. The logic is configured to perform the foregoing method.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as inventive code of block 200 for training a bidirectional encoder representations from transformers (BERT) model to use an intermediate representation (IR) input to output a software representation in the form of embedding, e.g., feature vectors, tensors, etc. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

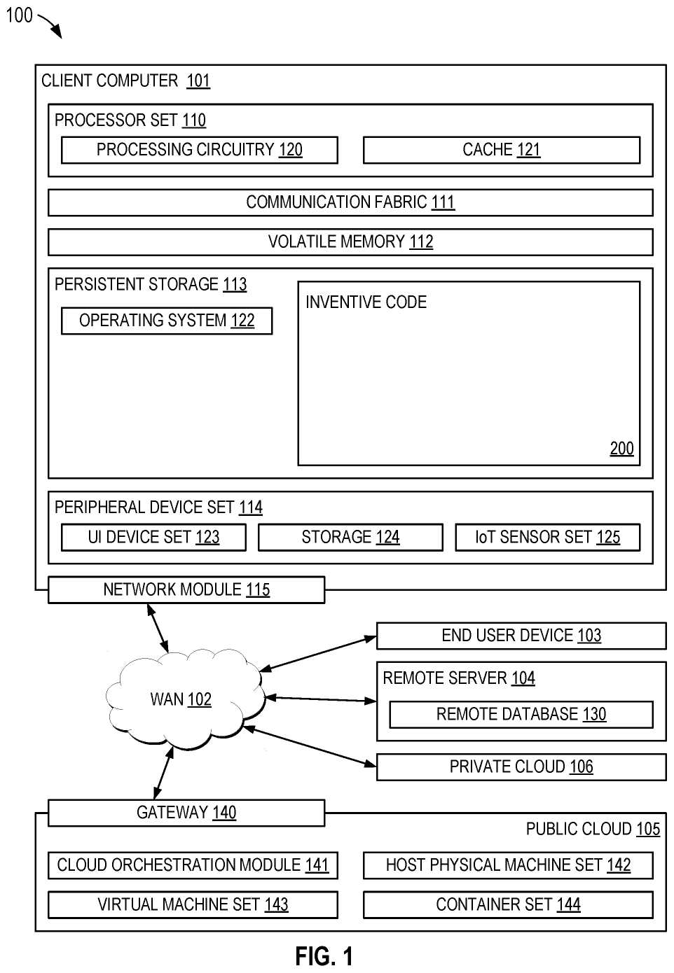

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

In some aspects, a system according to various embodiments may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various embodiments.

As mentioned elsewhere above, an IR is a data structure or code used internally by a compiler and/or virtual machine to represent source code. A relatively useful IR is typically accurate in that it is capable of representing the source code without losing information, yet independent of any particular source or target language. An IR may take one of several forms, e.g., such as an in-memory data structure.

Obtaining an accurate software representation is useful in many security applications, e.g., such as one-day vulnerability detection, malware detection, function signature inference, etc. As LLVM IR is more independent of a programming language, architecture, and platform than binary and source code is, in some cases, a software representation may be a relatively most effective layer to represent software.

Computation friendly representation of software may capture a semantic essence of the software code. This enables identification and similarity search at scale. A first use cases of computational friendly representations of software includes what may be referred to as “one-day discovery.” In one-day discovery, based on knowledge that there are some functions of software that are vulnerable, upon finding these functions in some other incoming executable, it may be concluded that the incoming executable is vulnerable. Another use case of the computational friendly representations of software is applicable to malware analysis. For example, binary of an incoming executable may be compared with known malicious binary and a score that represents a degree of similarity may be generated. Other use cases of computation friendly representation of software include, e.g., reverse engineering, software intelligence, etc.

There are several challenges to establishing and/or using computation friendly representations of software. For example, in some cases a source code may not always be available, and therefore details of the source code, e.g., such as binary, that is expected to be available may not be available. Another challenge is based on the fact that at least some binary may be architecture dependent binary code, e.g., the binary of may be different even though the source code is exactly the same. For example, an executable may include binary that is configured to be run on a first operating system, but not be configured to be run on a second operating system. This is a challenge because when considering computation friendly representations of software, it is preferable to be invariant of these dependencies. Furthermore, compiler and optimization variations pose a challenge because the semantics of the source code is expected to be consistent regardless of compiling differences and/or different dependencies. Fine-grained versus coarse-grained representation is also a challenge because although coarse-grained representation is relatively more scalable than fine-grained representation, it is less precise. For example, because an executable may include thousands of functions or more, being able to perform a scalable comparison for such an executable may be challenging.

In sharp contrast to the various deficiencies and challenges of conventional techniques representing software described above, various embodiments and approaches described herein include training a bidirectional encoder representations from transformers (BERT) model to output a software representation subsequent to an IR of a software package being input into the trained BERT model. More specifically, a core idea of these techniques includes using a dataflow embedded sequence as input for BERT to represent LLVM IR to enable a relatively improved representation of software than would otherwise be enabled. The dataflow embedded sequence in various approaches described herein includes tokens of defined variables, callee function names for call instructions, number constants, and/or used variables. Leveraging benefits enabled by using the dataflow embedded sequence, various embodiments and approaches described herein include a masked variable model, an instruction sentence value sentence pair prediction model, and pre-training objectives. With the dataflow embedded sequence, a relatively efficient and useful IR of software is enabled by leveraging the BERT model that is widely used in areas of natural language processing (NLP). This IR of the software is used as input for the trained BERT model, and a software representation of the software is received as an output. The software representation is in the form of embedding, e.g., feature vectors or tensors. Such a “software representation” in the form of embeddings allows potential further analysis, such as a large-scale software similarity computation. It should be noted that the techniques described in various embodiments and approaches herein are different from existing conventional techniques in that the dataflow embedded sequence and several pre-training objectives are used to thereby effectively capture data flow relationship in IR. The software representation generated by these novel techniques improve software representation beyond what is offered and more so lacking in existing solutions.

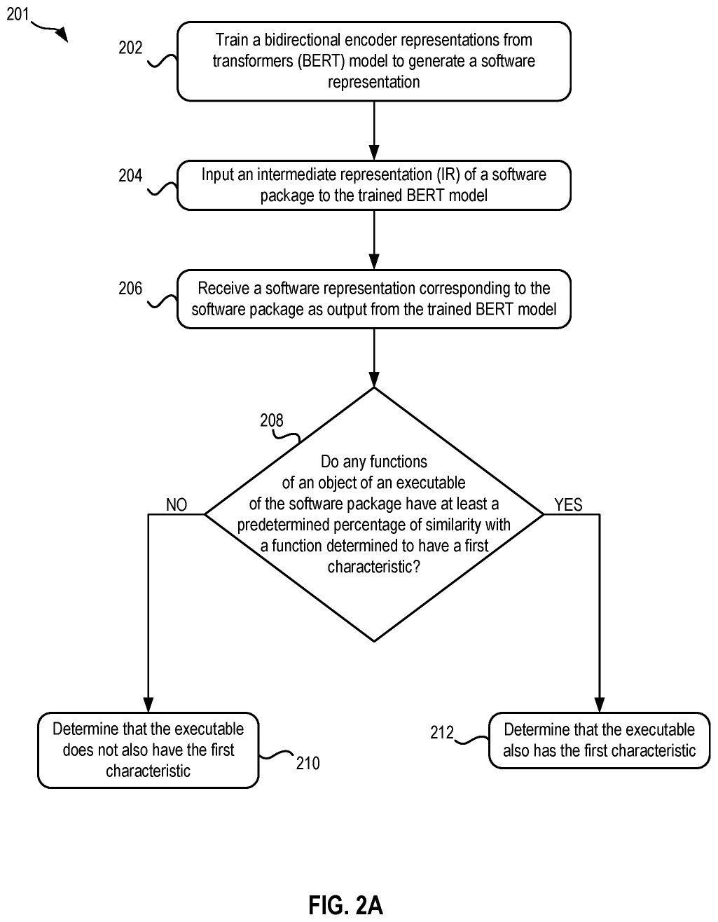

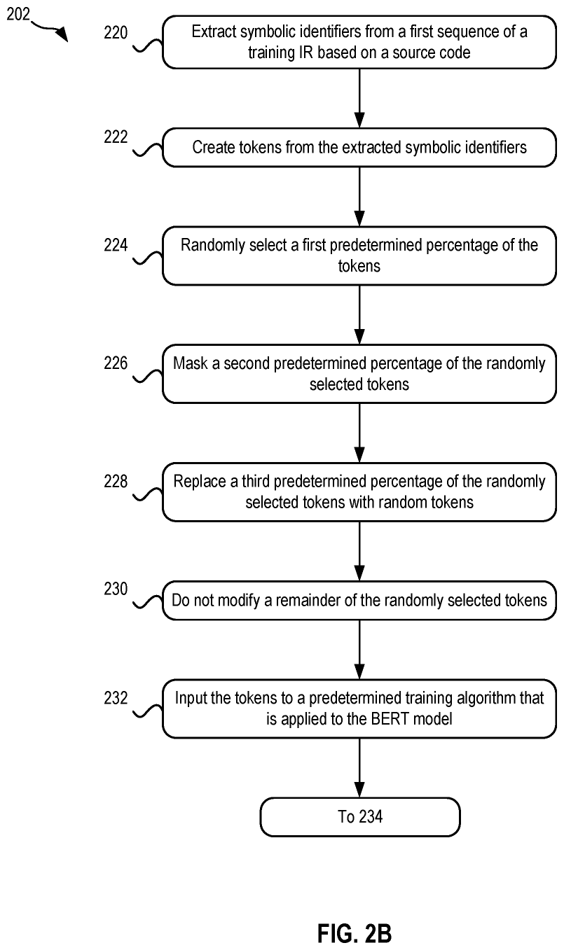

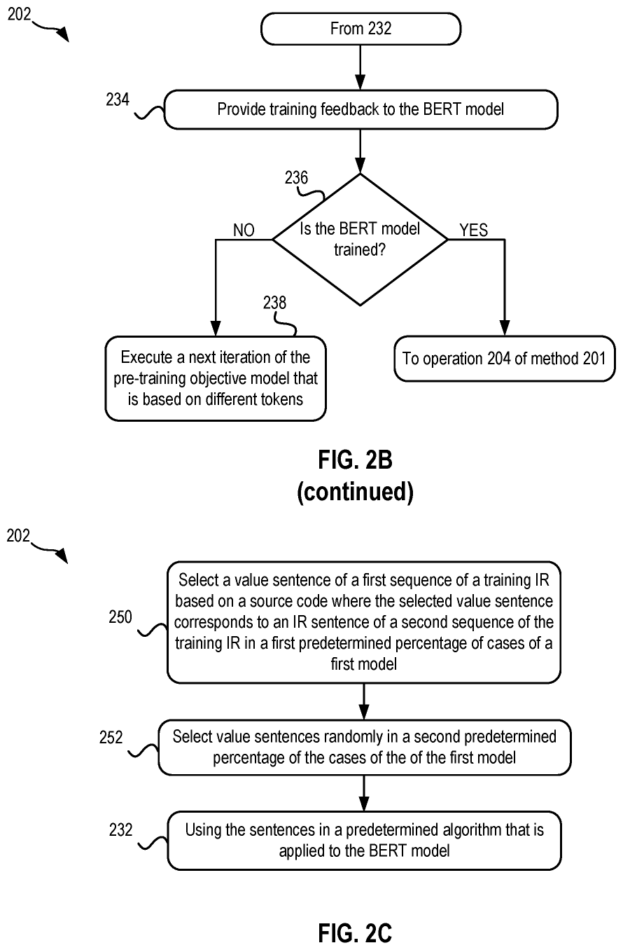

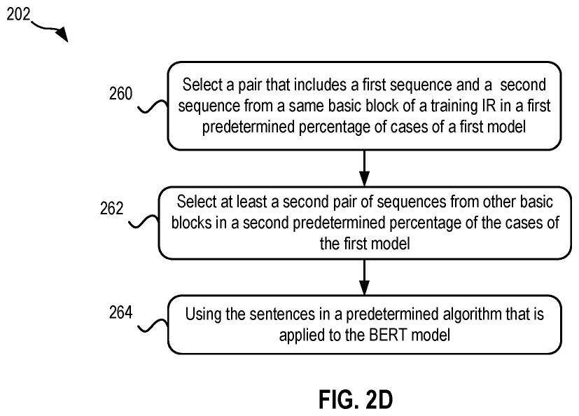

Now referring to FIG. 2A, a flowchart of a method 201 is shown according to one embodiment. The method 201 may be performed in accordance with the present invention in any of the environments depicted in FIGS. 1-7, among others, in various embodiments. Of course, more or fewer operations than those specifically described in FIG. 2A may be included in method 201, as would be understood by one of skill in the art upon reading the present descriptions.

Each of the steps of the method 201 may be performed by any suitable component of the operating environment. For example, in various embodiments, the method 201 may be partially or entirely performed by a computer, or some other device having one or more processors therein. The processor, e.g., processing circuit(s), chip(s), and/or module(s) implemented in hardware and/or software, and preferably having at least one hardware component may be utilized in any device to perform one or more steps of the method 201. Illustrative processors include, but are not limited to, a central processing unit (CPU), an application specific integrated circuit (ASIC), a field programmable gate array (FPGA), etc., combinations thereof, or any other suitable computing device known in the art.

Operation 202 of method 201 includes training a bidirectional encoder representations from transformers (BERT) model to generate a software representation, e.g., of a software package which may be input into the trained BERT model as an IR of the software package. It should be prefaced that the type of IR that is input for the BERT model subsequent to being trained may depend on the approach. For example, in a first approach the type of IR input into the trained BERT model includes an LLVM IR. In another approach, the type of IR input into the trained BERT model may include Vex IR. Furthermore, the software that the BERT model is trained to generate the software representation from may be a type of software that would become appreciated to one of ordinary skill in the art upon reading the descriptions herein. For example, according to various approaches, the software package may include, e.g., a known type of source code, anti-malware software, a received software packet, an update of a software program that is already loaded on and/or being run on a known type of user device, etc.

The BERT model may be a language representation model using a bidirectional encoder from a transformer. Training of the BERT model in some approaches includes two steps for various tasks. For example, a first task of training the BERT model may include pre-training the BERT model. The pre-training may include configuring the BERT model to utilize and/or interact with a at least one predetermined training algorithm. The second task of training the BERT model may include fine-tuning the BERT model, e.g., text classification, tagging, question answering, etc. For example, based on the BERT model being configured to utilize and/or interact with the at least one predetermined training algorithm described in task one, the BERT model may be instructed to perform one or more fine-tuning operations with performance feedback being provided to the BERT model thereafter to train the BERT model to generate a software representation of a software package. Various techniques for training the BERT model will now be described in several approaches below.

Looking to FIGS. 2B-2D, exemplary sub-operations of training a BERT model to generate a software representation are illustrated in accordance with various embodiments, one or more of which may be used to perform operation 202 of FIG. 2A. However, it should be noted that the sub-operations of FIGS. 2B-2D are illustrated in accordance with various embodiments which are in no way intended to limit the invention.

It may be prefaced that the BERT model may be trained with a pre-training objective that includes a model. In some approaches, the pre-training objective is an objective that the BERT model will be capable of performing as a result of the training. Such objectives are defined by one or more models. For example, referring first to FIG. 2B, the BERT model is trained with a first model of a pre-training objective that includes a first masked IR and value model. As will be described in various sub-operations below, the first masked IR and value model enables techniques that train the BERT model to accurately guess values within a software package that is input into the BERT model, as well as relationships that such values have among other functions within the software package. This allows the BERT model to generate a software representation of the software package and furthermore define characteristics of functions of objects of executables of such a software package, as will be described elsewhere herein.

With continued reference to FIG. 2B, sub-operation 220 includes extracting symbolic identifiers from a first sequence of a training IR based on a source code. The source code may be any known type of source code. In some approaches the source code may be compiled into machine code using one or more known compiling techniques that would become appreciated by one of ordinary skill in the art upon reading descriptions herein, and the training IR may be generated from the machine code, e.g., such as using a known lift technique that would become appreciated by one of ordinary skill in the art upon reading descriptions herein. In some other approaches, the training IR may be generated from the source code using techniques that would become appreciated by one of ordinary skill in the art upon reading descriptions herein. For example, in one approach, the training IR may be generated from the source code using tooling that includes a retargetable machine-code decompiler (RetDec). More specifically, the RETDEC may be used to lift a binary of the source code to generate a LLVM IR of the source code, e.g., where the LLVM is used at the training IR. In some approaches, supported file formats when using the RETDEC may include, e.g., executable and linkable format (ELF), portable executable (PE), mach object file format (Mach-O), common object file format (COFF), archive (AR) file format, Intel hexadecimal (HEX) object file format, raw machine code, etc. Furthermore, various supported architectures include, e.g., x86-32, ARM-32, MIPS-32, PowerPC-32, X86-64, ARM-64, etc.

In some approaches, tooling may additionally and/or alternatively used to extract symbolic identifiers from the first sequence of the training IR. For example, the tooling may include a LLVM. The LLVM may be used to extract instructions and values from the training IR. More specifically, in some approaches, a collection of modular and reusable compiler and toolchain may be generated by using the LLVM tooling. Note that a number of LLVM IR-based analysis tools may be available and used depending on the approach.

In some other approaches, the tooling may additionally and/or alternatively include code-prep with spiral. The code-prep with spiral may be used to split symbolic identifiers, e.g., function name and/or type, into substrings. The codeprep with spiral may additionally and/or alternatively serve as a tool for preprocessing source code corpora and/or providing splitters for identifiers in source code files.

The type of first sequence of the training IR may depend on the approach. For example, in one approach, the first sequence may be an instruction sequence that includes a plurality of instructions that each correspond to at least one instruction within the source code. In another approach, the first sequence may be a value sequence, that includes a plurality of values that exist interspersed among and are used by the instructions of the source code. In yet another approach, the first sequence may be a position sequence extracted from pre-processing of the training IR. The position sequence includes values which may be arranged in a vector that characterize a sequence of the instructions of the source code. For context, manipulations of these sequences are used as training input in various approaches, e.g., see FIGS. 2B-2D, to enable a learning phase of the BERT model.

Sub-operation 222 of FIG. 2B, includes creating tokens from the extracted symbolic identifiers. For context, a token may be defined as an independently meaningful subsequence of characters in the a given sequence, e.g., identifiers, keywords, string constants, operators, etc. Accordingly, in some approaches, assuming that the first sequence is an instruction sequence that includes a plurality of instructions, creating the tokens from the extracted symbolic identifiers may include identifying one or more lines of instructions of the sequence. In sub-operation 224, training with the first model includes randomly selecting a first predetermined percentage, e.g., 5%, 15%, 25%, 50%, 75%, etc., of the entire tokens in each instruction sequence and value sequence of the training IR where the training IR is based on, e.g., extracted from the source code. In one preferred approach, the first predetermined percentage is 15% of the entire tokens in each instruction sequence and value sequence of the training IR. A second predetermined percentage, e.g., 25%, 50%, 75%, 80%, 90%, etc., of the randomly selected tokens may be masked, e.g., see sub-operation 226. In one preferred approach, the second predetermined percentage includes 80% of the randomly selected tokens. The second predetermined percentage of the randomly selected tokens may be masked by inserting a known type of making command into sentences of the training IR that include one or more of the second predetermined percentage of the randomly selected tokens, e.g., such as [[“local_var0”], [“<mask>”] which includes a “mask” command in a sentence of an illustrative training IR that includes one of the randomly selected tokens. Furthermore, a third predetermined percentage, e.g., 5%, 10%, 20%, etc., of the randomly selected tokens may be replaced with random tokens, e.g., see sub-operation 228. In one preferred approach the third predetermined percentage includes 10% of the randomly selected tokens. Finally, a remainder of the randomly selected tokens, e.g., the randomly selected tokens that are not masked and that are not replaced, may be not modified, e.g., see sub-operation 230. In one preferred approach, the remainder includes 10% of the randomly selected tokens.

The tokens, e.g., randomly selected tokens subsequent to the modifications, are input to a predetermined training algorithm that is applied to the BERT model, e.g., see sub-operation 232. The predetermined training algorithm may be one that would become appreciated by one of ordinary skill in the art upon reading descriptions herein. In some preferred approaches, training the BERT model using the first model includes instructing the BERT model to guess the masked tokens. The predetermined training algorithm may also instruct the BERT model to consider the unmasked tokens in the process of guess the masked tokens. For example, the unmasked token may provide a context of the instruction sequence and/or the value sequence to the BERT model that is used to guess what the masked tokens of an instruction sequence and/or the value sequence are.

Training feedback may be provided to the BERT model, e.g., see sub-operation 234. For example, an accuracy of the BERT model to consider the unmasked tokens and/or a context of the sequences and accurately guess the masked tokens may be refined by providing the BERT model with a known type of negative and/or corrective feedback in response to a determination that the BERT model incorrectly guesses one or more of the masked tokens. An accuracy of the BERT model to consider the unmasked tokens and/or a context of the sequences and accurately guess the masked tokens may be refined by providing the BERT model with positive feedback in response to a determination that the BERT model correctly guesses one or more of the masked tokens. With such feedback, the BERT is trained to relatively more accurately guess the masked tokens and thereby understand how to generate an IR as a result of working with the training IR.

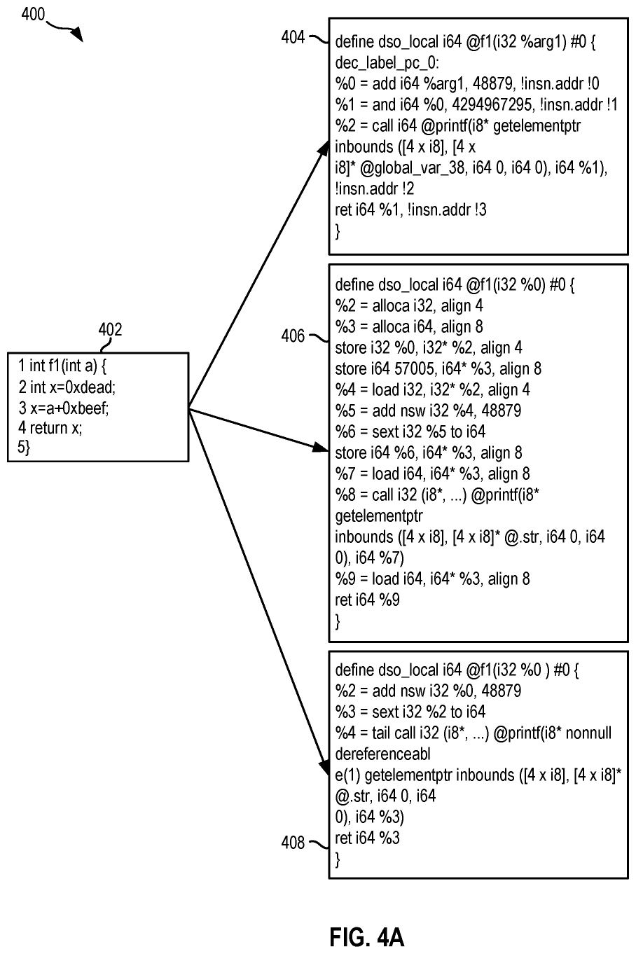

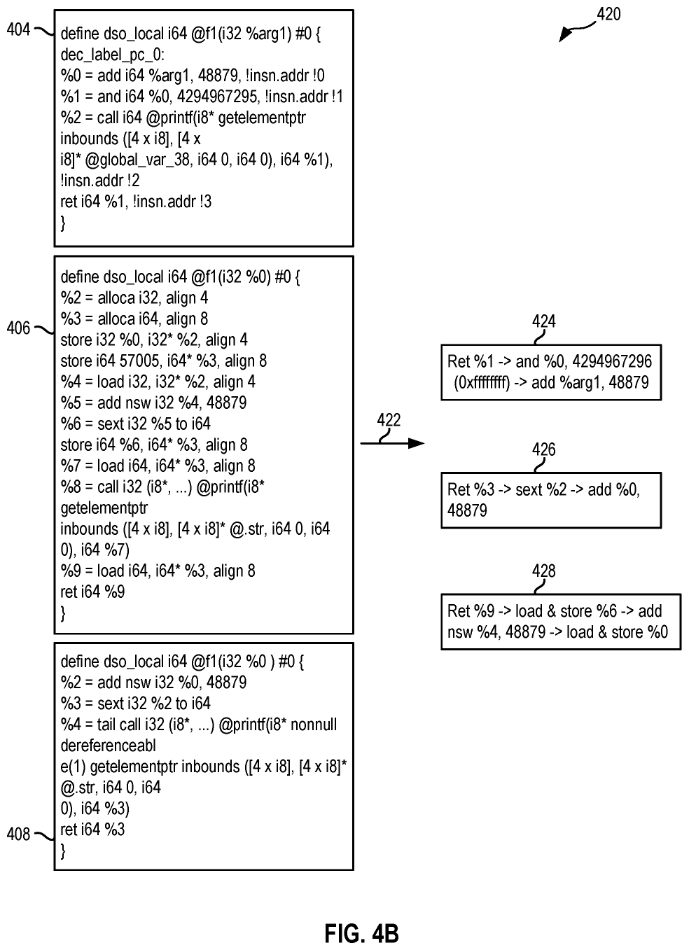

It may be determined whether the BERT model is trained, e.g., see sub-operation 236. In some approaches, such a determination may be based on an accuracy that the BERT model is able to correctly guess the masked tokens. In some approaches, once the BERT model is able to successfully guess mask tokens, the BERT model is trained with a sufficiency that allows the BERT model to look at functions of among different executables and determine a similarity of such functions. In some approaches the BERT model may be determined to be trained in response to a determination that the accuracy that the BERT model is able to correctly guess the masked tokens is greater than or equal to a predetermined threshold, e.g., 50%, 70%, 75%, 90%, 95%, etc. In some approaches the BERT model may be determined to not be trained in response to a determination that the accuracy that the BERT model is able to correctly guess the masked tokens is not greater than or equal to the predetermined threshold. In response to a determination that the BERT model is not trained, e.g., as illustrated by the “NO” logical path of decision 238, a next iteration of the pre-training objective model may be executed, e.g., see sub-operation 238. For example, the BERT model may be trained by iteratively considering a plurality of variations of the pre-training objective, where each iteration is based on different tokens of the training IR. In one approach, in a subsequent iteration of the pre-training model, new tokens may be created and various operations of training with the first model may be performed with respect to the new tokens to train the BERT model, e.g., see sub-operations 224-236. In some approaches, the new tokens may be from different training IR, e.g., a different IR that is based on the same source code. Note that each of the different IRs are in some preferred approaches based on, e.g., extracted from, the same source code but include different instructions, e.g., gcc-03, clang-00 and clang-03 of FIG. 4 elsewhere herein. In response to a determination that the BERT model is trained, it may be determined that the BERT model is ready to use, e.g., as illustrated by the “YES” logical path of decision 238 continue to operation 204 of method 201.

Referring now to FIG. 2C, the BERT model is trained with a second model of a pre-training objective that includes an IR and value pair prediction model. As will be described in various sub-operations below, the second model, e.g., the IR and value pair prediction model, enables techniques that train the BERT model to accurately predict values within a software package that is input into the BERT model, as well as relationships that such values have among other functions that use such values within the software package.

Sub-operation 250 of FIG. 2C includes selecting a value sentence of a first sequence, e.g., a value sequence, of a training IR based on, e.g., extracted from, a source code. The selected value sentence in some preferred approaches corresponds to, e.g., is used in, an IR sentence of a value sequence of the training IR in a first predetermined percentage, e.g., 25%, 50%, 75%, etc., of cases of the second model. In some approaches, the first predetermined percentage includes 50% of cases of the second model. For context, the cases of the second model may be used for training the BERT model and thereby having at least 50% of the sentences correspond with one another will provide at least some successful cases of execution by the BERT model during training. This ensures at least some positive feedback being available for training the BERT model. Without such positive feedback it would take significantly longer and/or be potentially not possible for the BERT model to be trained via training with feedback. Sub-operation 252 includes selecting value sentences randomly in a second predetermined percentage, e.g., 25%, 50%, 75%, etc., of the cases of the first model. In some approaches, the second predetermined percentage includes a remainder 50% of cases of the second model.

The sentences are used in a predetermined algorithm that is applied to the BERT model, e.g., see sub-operation 232. The predetermined algorithm may instruct the BERT model to predict value pairings among the different sentences. For example, an accuracy of the BERT model to consider the sentences and/or a context of sentences within the sequences and accurately guess value pairings may be refined by providing the BERT model with a known type of negative and/or corrective feedback, e.g., via a known type of reinforcement learning feedback algorithm, in response to a determination that the BERT model incorrectly guesses one or more of the value pairing, and providing the BERT model with a known type of positive feedback in response to a determination that the BERT model correctly guesses one or more value pairings. Similar refinement and/or iterative techniques described elsewhere herein with respect to the first model may be utilized to ensure that the BERT model is trained, e.g., such as until an accuracy that the BERT model is able to correctly guess the value pairs is greater than or equal to a predetermined threshold of accuracy. In response to a determination that the BERT model is trained, it may be determined that the BERT model is ready to use, and the process may optionally continue to operation 204 of method 201.

Referring now to FIG. 2D, the BERT model is trained with a third model of a pre-training objective that includes a next basic block prediction model. As will be described in various sub-operations below, the third model, e.g., next basic block prediction model, enables techniques that train the BERT model to accurately predict a next basic block from a given basic block within a software package that is input into the BERT model. Sub-operation 260 includes selecting a pair that includes a first sequence and a second sequence from a same basic block of a training IR in a first predetermined percentage of cases of the first model. In some preferred approaches, the first sequence is an instruction sequence, and the second sequence is a value sequence, and the first predetermined percentage is 50% of cases. Furthermore, at least a second pair of sequences are selected from other basic blocks in a second predetermined percentage, e.g., preferably about a remainder 50% of the cases, of the cases of the third model, e.g., see sub-operation 262. For context, it should be noted that the cases of the first pair are functionally related to one another based on being from the same basic block of the training IR model. In contrast, the sentences of the second pair are not of the same basic block of the training IR model and therefore will likely not be functionally related with one another. These sentences of the first pair and at least the second pair establishing a training set that may be used in a predetermined algorithm that is applied to the BERT model, e.g., see sub-operation 264. In one approach the predetermined algorithm may instruct the BERT model to predict whether a given one of the sentences is of the same basic block as another given sentence or not. For example, an accuracy of the BERT model to consider a given one of the sentences and guess whether the sentence is within the same basic as another one of the sentences may be refined by providing the BERT model with a known type of negative and/or corrective feedback in response to a determination that the BERT model incorrectly guesses the next basic block of a given sentence, and providing the BERT model with a known type of positive feedback in response to a determination that the BERT model correctly guesses the next basic clock of the given sentence. Similar refinement and/or iterative techniques described elsewhere herein with respect to incorporating reinforcement learning feedback into the first model and/or the second model may be utilized to ensure that the BERT model is trained, e.g., such as until an accuracy that the BERT model is able to correctly guess a next basic block is greater than or equal to a predetermined threshold of accuracy. In response to a determination that the BERT model is trained, it may be determined that the BERT model is ready to use, and the process may optionally continue to operation 204 of method 201.

With reference again to FIG. 2A, assuming that the BERT model is trained to generate a software representation of software, an IR of a software package may be input into the trained BERT model, e.g., see operation 204 of method 201. In some approaches, the input of the BERT model may be the IR of the software package and a corresponding dataflow embedded sequence that is precomputed give the IR. One or more techniques for inputting a software package to a BERT that would become appreciated by one of ordinary skill in the art upon reading descriptions herein may be utilized. In some approaches the BERT model may be issued an instruction to generate the software representation of the software package. Note that the software package may be of a known type and may include one or more similar types of operations to those of the software that the BERT model was trained using.

Operation 206 includes receiving a software representation corresponding to the software package as output from the trained BERT model. The software representation received as the output from the trained BERT model may be in the form of embedding. This embedding is based on BERT-based model. In some approaches, the embedding may be a vector representation of the software package. In some other approaches, the embedding may additionally and/or alternatively be a tensor representation of the software package. In some approaches the software representation received as the output from the trained BERT model may include embedded functions that would become appreciated by one of ordinary skill in the art upon reading descriptions herein.

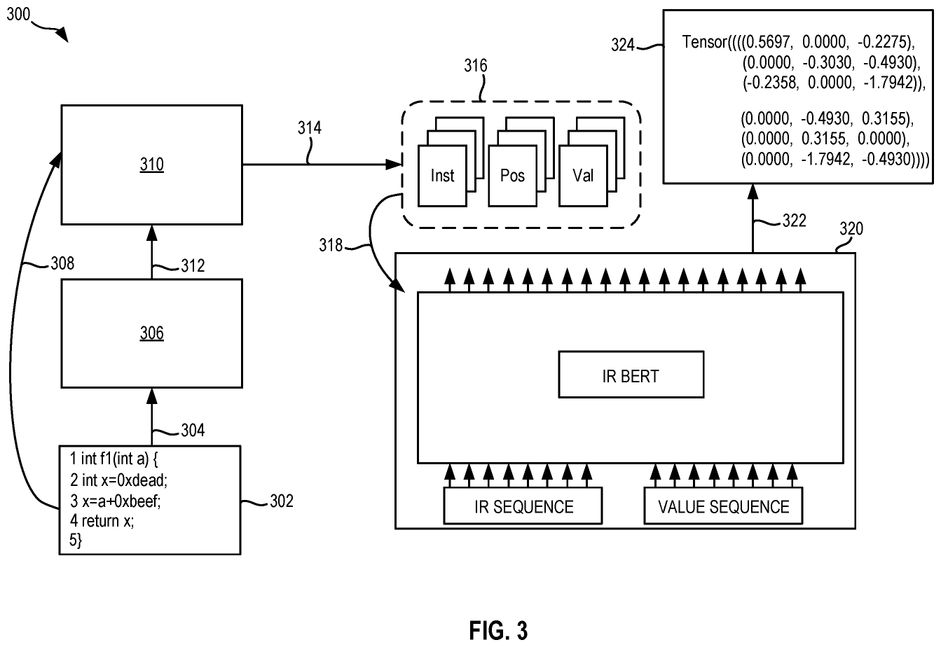

The software representation in the form of embeddings enables potential further analysis to be performed, such as a large-scale software similarity computation. In some approaches, by extracting a software representation at the function-level granularity, such representations and embeddings can also be called function embeddings, e.g., see 324 of FIG. 3, which is the output of the system.

The software representation received as output from the trained BERT model may be used to determine whether any functions of an object of an executable of the software package have at least a predetermined percentage of similarity with a function determined to have a first characteristic, e.g., see decision 208. The first characteristic may be any known type of characteristic associated with software packages, e.g., such as trustworthy, untrustworthy such as malware, etc. It should be noted that although decision 208 is described above to be performed with respect to a “first characteristic,” in some approaches decision 208 may be performed with respect to a plurality of predetermined characteristics which may each be considered with respect to a different predetermined percentage of similarity. This determination of similarity may be performed to establish one or more characteristics of the software packet. For example, in response to a determination that at least one of the functions of an object of an executable of the software package have at least a predetermined percentage of similarity with a function, e.g., which may be included in a table that includes a plurality of predetermined functions and associated characteristics, determined to have a first characteristic, e.g., as illustrated by the “YES” logical path of decision 208, it may be determined that the executable that includes the function also has the first characteristic, e.g., see operation 212. In some approaches one or more predetermined actions may be performed in response to one or more functions being determined to have one or more predetermined characteristics. This may be particularly useful where the software package is input into the BERT model for vetting the software package, e.g., ensuring that the software package does not include any malicious functions. For example, in response to a determination that a first function of a software representation corresponding to an output from the trained BERT model has at least a predetermined percentage of similarity with one or more predetermined malware functions, the first function may be determined to be a malware function that is not trustworthy, and the software package that includes the first function may be prevented from being executed from one or more devices. A name of the software package that includes the first function may additionally and/or alternatively be output to a database with information detailing why the software package should not be trusted. Accordingly, regardless of compiling differences and/or different dependencies in a software package, the BERT model is able to generate a software representation, e.g., “function embedding,” that lists characteristics of functions of the software package.

In contrast, in response to a in response to a determination that at least one of the functions of an object of an executable of the software package do not have at least a predetermined percentage of similarity with a function, e.g., as illustrated by the “NO” logical path of decision 208, it may be determined that the executable that includes the function does not have the first characteristic, e.g., see operation 210. For purposes of an example, assuming that the first characteristic includes malicious malware, the software package may be allowed to be run on one or more devices based on the determination that executables of the software package do not include functions that have malicious malware characteristics.

Numerous benefits are enabled as a result of utilizing one or more techniques described in various embodiments and approaches herein. For example, it may be noted that training of the BERT model described herein enables the BERT model to define characteristics of software down to the function level of an object of an executable. It should be noted that a human is not capable of determining such characteristics and/or an extent of a software representation because various embodiments described herein specify use of a teaching a BERT model with reinforcement learning. Furthermore, such an extent of studying software to determine such characteristics is far beyond what may be described as a practical task for a human, as there are multiple levels of the software that may be considered to determine such characteristics, e.g., an executable level, an object level and a function level. Accordingly, the techniques described herein would be not possible to recreate and/or perform merely using the human mind.

It should also be noted that use of a trained BERT model to output a software representation of a software package has heretofore not been considered in conventional techniques. This is proven in the fact that the techniques described herein enable efficiencies in the process of determining a software representation of a software packet. For example, it should be noted that inventors have uncovered significant efficiency improvements while testing several binaries using both conventional calculation of cosine similarity and the training techniques described herein. In a preliminary evaluation result, these findings reveal that, across multiple levels of optimization, a BERT model trained using the techniques described in various embodiments and approaches herein outperformed conventional techniques when evaluating the same binary executables. Accordingly, the inventive discoveries disclosed herein with regards to training a BERT model to generate a software representation of software proceed contrary to conventional wisdom.

FIG. 3 depicts a representational architecture 300, in accordance with one embodiment. As an option, the present representational architecture 300 may be implemented in conjunction with features from any other embodiment listed herein, such as those described with reference to the other FIGS. Of course, however, such representational architecture 300 and others presented herein may be used in various applications and/or in permutations which may or may not be specifically described in the illustrative embodiments listed herein. Further, the representational architecture 300 presented herein may be used in any desired environment.

Representational architecture 300 includes source code 302 of a known type. The source code 302 may be compiled into machine code 306, e.g., see compiling operation 304. The source code 302 may be additionally and/or alternatively converted into training IR 310, e.g., see operation 308. The machine code 306 may be converted into the training IR 310, e.g., by a lift operation 312. Pre-processing with control-flow and data-flow analysis 314 may be performed on the training IR 310 to generate at least one sequence, e.g., instruction token sequences (Inst), position token sequences (Pos) and value token sequence (Val). Tokens may be extracted from the token sequences 316 and used, e.g., see operation 318, to train a BERT model, e.g., see IR BERT of model 320, to generate a software representation of software subsequent to an IR of a software package being input into the trained BERT model. In some illustrative approaches, before the BERT model is trained to generate the software representation, the BERT model may be designed for processing natural language for a variety of language related tasks. Such a BERT model may be taken as a blackbox and used for IR representation. In some approaches, instruction token sequences, e.g., see IR SEQUENCE, and value token sequences, e.g., see VALUE SEQUENCE, may be taken as input. LLVM functions pass may be employed to extract instruction a token sequence and a value token sequence from LLVM IR. Symbolic identifiers in the instruction token sequence may be treated specially to avoid an out-of-vocabulary problem, and therefore they may be broken into substrings considering code semantics, e.g., by using a known type of codeprep. The customized BERT model described herein may be pretrained with three pretraining objectives, e.g., 1) an IR and value masked model, 2) an IR and value pair prediction model, and 3) a next basic block prediction model. In one illustrative approach, the IR and value masked model may include randomly selecting 15% of entire tokens, masking 80% of them, replacing 10% of them with random token, and un-modifying the rest. In some approaches, an IR and value masked model classifier may be used to calculate loss by predicting original tokens of selected ones. During this process, the model can understand a bidirectional context of IR and value sequences. This enables an IR of a software package to be input into the trained BERT model, and the trained BERT model to output a software representation corresponding to the software package, e.g., see operation 322. For example, the output may include a tensor IR 324 based on an instruction-grained control flow and data flow. The IR and value pair prediction model is a variant of the next sentence prediction model, which is described elsewhere herein, e.g., see FIG. 2C. In the next sentence prediction model, e.g., also referred to above as the “IR and value pair prediction model,” a value sentence corresponding to the IR sentence is selected in 50% of cases. In another 50% of cases, the value sentence is selected randomly. By predicting at least some correct instruction and value sentence pairs, the BERT model gains an understanding of a relationship between instructions and value sequences. Another model of training the BERT model include a next basic block prediction model, e.g., see FIG. 2D, which includes selecting pairs of instruction and value sequences. The pairs are selected from same basic block in 50% of cases and are selected from other basic block in a remainder of the cases. By predicting correct pairs from same basic block, the BERT model gains an understanding of basic block-grained control flow.

FIG. 4A-4B depict representations 400, 420 of sample IRs, in accordance with various embodiments. As an option, the present representations 400, 420 may be implemented in conjunction with features from any other embodiment listed herein, such as those described with reference to the other FIGS. Of course, however, such representations 400, 420 and others presented herein may be used in various applications and/or in permutations which may or may not be specifically described in the illustrative embodiments listed herein. Further, the representations 400, 420 presented herein may be used in any desired environment.

Referring first to FIG. 4A, the representation 400 includes a first IR 404, a second IR 406 and a third IR 408 that are each extracted from source code 402. In some approaches, the IRs 404, 406, 408, which may also be referred to as “embeddings” may be extracted from the source code 402 by executing a known type of compiling operation. For example, in one approach, the first IR 404 is extracted from the source code 402 using a GNU compiler collection operation, e.g., gcc-O3 which may include a third level of optimization. In another example, the second IR 406 is extracted from the source code 402 using a clang compile operation, e.g., clang-O0 with may have no optimization. In yet another example, the third IR 408 is extracted from the source code 402 using a clang compile operation, e.g., clang-O3 with may have a third level of optimization.

It should be noted that because the first IR 404, the second IR 406 and the third IR 408 are extracted from the same source code 402, the IRs each have the same computational semantics. Accordingly, although the IRs have different lines of instructions therein, a BERT model is preferably trained to recognize these same computational semantics and output the same software representations for each in the event that the IR 404-408 are input into the trained BERT model.

Referring now to FIG. 4B, in representation 420, the concept that each of the IRs 404-408 have the same computational semantics is evident. For example, a data-flow analysis 422, e.g., from retval, may be performed to reveal a plurality of return instructions 424, 426 and 428 that are each associated with a different one of the IRs 404-408. For example, the return instruction 424 is associated with the first IR 404, the return instruction 426 is associated with the second IR 406, and the return instruction 426 is associated with the third IR 408. It may be noted that the same computational semantics of the IRs 404-408 is evident in that each of the return instructions 424-428 return a common value, e.g., see 48879.

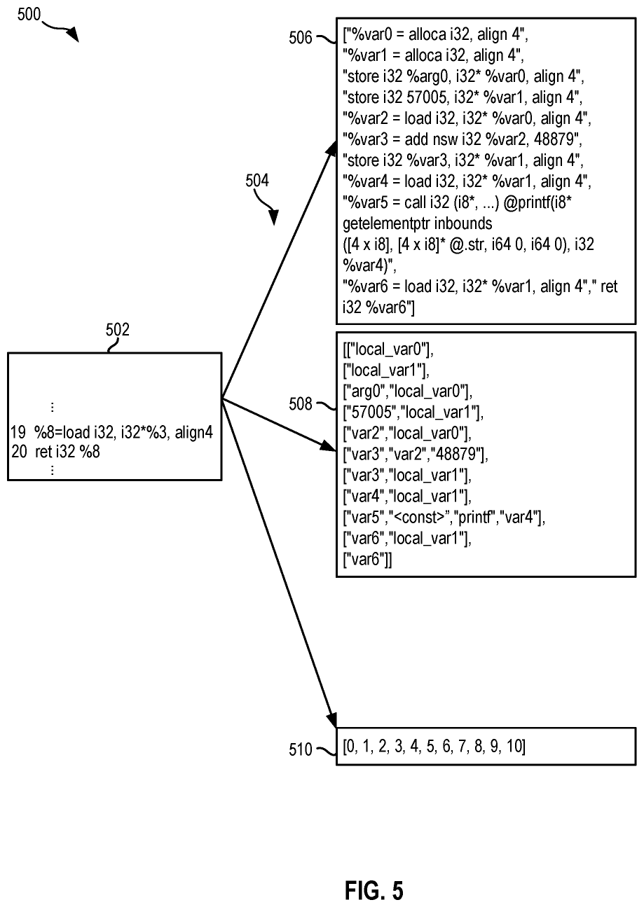

FIG. 5 depicts a representation 500, in accordance with one embodiment. As an option, the present representation 500 may be implemented in conjunction with features from any other embodiment listed herein, such as those described with reference to the other FIGS. Of course, however, such representation 500 and others presented herein may be used in various applications and/or in permutations which may or may not be specifically described in the illustrative embodiments listed herein. Further, the representation 500 presented herein may be used in any desired environment.

The representation 500 includes a training IR 502 and a plurality of sequences that are based on, e.g., extracted using an extraction command 504, the training IR. For example, a first sequence 506 based on the training IR 502 may be an instruction sequence. Furthermore, a second sequence 508 based on the training IR 502 may be a value sequence. Additionally, a third sequence 510 based on the training IR 502 may be a position sequence.

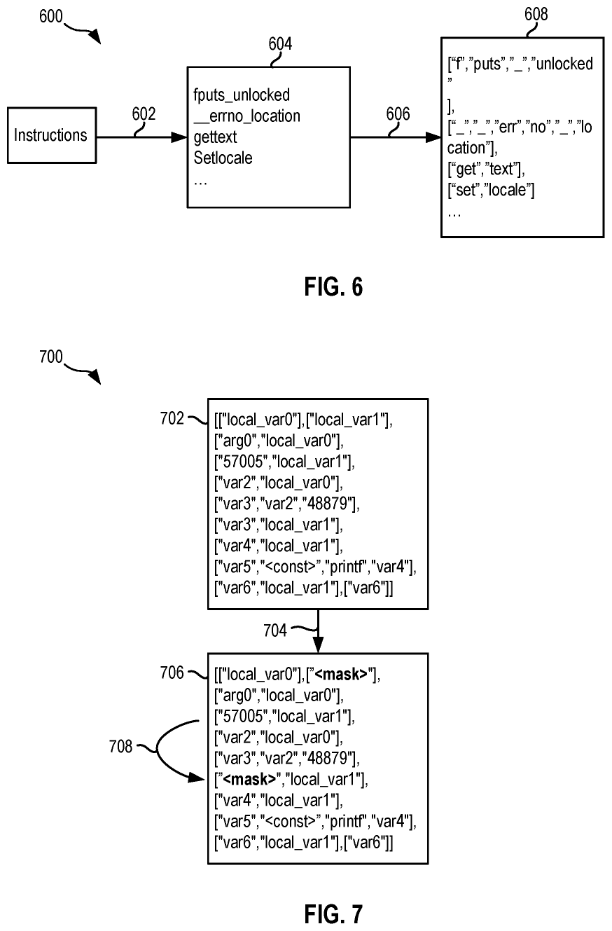

FIG. 6 depicts a progression 600 of splitting symbolic identifiers, in accordance with one embodiment. As an option, the present progression 600 may be implemented in conjunction with features from any other embodiment listed herein, such as those described with reference to the other FIGS. Of course, however, such progression 600 and others presented herein may be used in various applications and/or in permutations which may or may not be specifically described in the illustrative embodiments listed herein. Further, the progression 600 presented herein may be used in any desired environment.

In a first step 602, symbolic identifiers 604 may be extracted from instructions, e.g., see Instructions. In a second step 606 of progression 600, a known technique of preparing code, e.g., codeprep, may be performed on the extracted symbolic identifiers 604 to generate tokens 608 that may be used for training a BERT model to generate a software representation of software.

FIG. 7 depicts a representation 700, in accordance with one embodiment. As an option, the present representation 700 may be implemented in conjunction with features from any other embodiment listed herein, such as those described with reference to the other FIGS. Of course, however, such representation 700 and others presented herein may be used in various applications and/or in permutations which may or may not be specifically described in the illustrative embodiments listed herein. Further, the representation 700 presented herein may be used in any desired environment.

Representation 700 includes a first sequence 702 that may be a value sequence. In one preferred approach, 15% of all tokens in the first sequence 702 may be selected at random to thereafter predict by a BERT model during training of the BERT model, e.g., see prediction 708. For example, the second sequence 706 may be a version of the first sequence 702 with 80% of the tokens are masked, e.g., see operation 704, and variables “local_var1” and “var4” replaced with “<mask>” in the second sequence 706. Furthermore, in one preferred approach, 10% of the selected tokens are replaced with a random token, and a remainder of the selected tokens are left unmodified.

It will be clear that the various features of the foregoing systems and/or methodologies may be combined in any way, creating a plurality of combinations from the descriptions presented above.

It will be further appreciated that embodiments of the present invention may be provided in the form of a service deployed on behalf of a customer to offer service on demand.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
training a bidirectional encoder representations from transformers (BERT) model to generate a software representation;
inputting an intermediate representation (IR) of a software package to the trained BERT model; and
receiving a software representation corresponding to the software package as output from the trained BERT model.

2. The computer-implemented method of claim 1, wherein the software representation received as the output from the trained BERT model is in a form of embedding.

3. The computer-implemented method of claim 2, wherein the embedding is selected from the group consisting of: a vector representation of the software package and a tensor representation of the software package.

4. The computer-implemented method of claim 1, wherein the BERT model is trained with a pre-training objective that includes a first model, wherein training with the first model includes: randomly selecting a first predetermined percentage of tokens of a training IR based on a source code, masking a second predetermined percentage of the randomly selected tokens, replacing a third predetermined percentage of the randomly selected tokens with random tokens, and not modifying a remainder of the randomly selected tokens.

5. The computer-implemented method of claim 4, wherein training with the first model includes: extracting symbolic identifiers from a first sequence of the training IR, and creating the tokens from the extracted symbolic identifiers.

6. The computer-implemented method of claim 4, wherein the BERT model is trained by iteratively considering a plurality of variations of the pre-training objective, wherein each iteration is based on different tokens of the training IR.

7. The computer-implemented method of claim 1, wherein the BERT model is trained with a pre-training objective that includes a first model, wherein training with the first model includes: selecting a value sentence of a first sequence of a training IR based on a source code, wherein the selected value sentence corresponds to an IR sentence of a second sequence of the training IR in a first predetermined percentage of cases of the first model, and selecting value sentences randomly in a second predetermined percentage of the cases of the first model.

8. The computer-implemented method of claim 1, wherein the BERT model is trained with a pre-training objective that includes a first model, wherein training with the first model includes:
selecting a pair that includes a first sequence and a second sequence from a same basic block of a training IR in a first predetermined percentage of cases of the first model, and selecting at least a second pair of sequences from other basic blocks in a second predetermined percentage of the cases of the first model.

9. The computer-implemented method of claim 1, comprising: using the software representation received as output from the trained BERT model to determine whether any functions of an object of an executable of the IR of the software package have at least a predetermined percentage of similarity with a function determined to have a first characteristic; and in response to a determination that at least one function of the object of the executable has at least the predetermined percentage of similarity with the function determined have the first characteristic, determining that the executable also has the first characteristic.

10. The computer-implemented method of claim 9, wherein the first characteristic is selected from the group consisting of: trustworthy and untrustworthy.

11. A computer program product, the computer program product comprising a computer readable storage medium having program instructions embodied therewith, the program instructions readable and/or executable by a computer to cause the computer to:
train, by the computer, a bidirectional encoder representations from transformers (BERT) model to generate a software representation;
input, by the computer, an intermediate representation (IR) of a software package to the trained BERT model; and
receive, by the computer, a software representation corresponding to the software package as output from the trained BERT model.

12. The computer program product of claim 11, wherein the software representation received as the output from the trained BERT model is in a form of embedding.

13. The computer program product of claim 11, wherein the BERT model is trained with a pre-training objective that includes a first model, wherein training with the first model includes: randomly selecting a first predetermined percentage of tokens of a training IR based on a source code, masking a second predetermined percentage of the randomly selected tokens, replacing a third predetermined percentage of the randomly selected tokens with random tokens, and not modifying a remainder of the randomly selected tokens.

14. The computer program product of claim 13, wherein training with the first model includes: extracting symbolic identifiers from a first sequence of the training IR, and creating the tokens from the extracted symbolic identifiers.

15. The computer program product of claim 13, wherein the BERT model is trained by iteratively considering a plurality of variations of the pre-training objective, wherein each iteration is based on different tokens of the training IR.

16. The computer program product of claim 11, wherein the BERT model is trained with a pre-training objective that includes a first model, wherein training with the first model includes: selecting a value sentence of a first sequence of a training IR based on a source code, wherein the selected value sentence corresponds to an IR sentence of a second sequence of the training IR in a first predetermined percentage of cases of the first model, and selecting value sentences randomly in a second predetermined percentage of the cases of the first model.

17. The computer program product of claim 11, wherein the BERT model is trained with a pre-training objective that includes a first model, wherein training with the first model includes:
selecting a pair that includes a first sequence and a second sequence from a same basic block of a training IR in a first predetermined percentage of cases of the first model, and selecting at least a second pair of sequences from other basic blocks in a second predetermined percentage of the cases of the first model.

18. The computer program product of claim 11, the program instructions readable and/or executable by the computer to cause the computer to: use, by the computer, the software representation received as output from the trained BERT model to determine whether any functions of an object of an executable of the IR of the software package have at least a predetermined percentage of similarity with a function determined to have a first characteristic; and in response to a determination that at least one function of the object of the executable has at least the predetermined percentage of similarity with the function determined have the first characteristic, determine, by the computer, that the executable also has the first characteristic.

19. The computer program product of claim 18, wherein the first characteristic is selected from the group consisting of: trustworthy and untrustworthy.

20. A system, comprising:
a processor; and
logic integrated with the processor, executable by the processor, or integrated with and executable by the processor, the logic being configured to:
train a bidirectional encoder representations from transformers (BERT) model to generate a software representation;
input an intermediate representation (IR) of a software package to the trained BERT model; and
receive a software representation corresponding to the software package as output from the trained BERT model.
